(19) United States
(12) Patent Application Publication
(10) Pub. No.: US 2025/0244547 A1
(43) Pub. Date: Jul. 31, 2025

(54) INTEGRATED COMPOUND SEMICONDUCTOR CO-PACKAGED OPTICS

(71) Applicant: II-VI Delaware, Inc., Wilmington, DE (US)

(72) Inventors: Young-Kai Chen, Wilmington, DE (US); Anna Tatarczak, Wilmington, DE (US); Peter Szabo, Wilmington, DE (US); Andrei Kaikkonen, Wilmington, DE (US); Nicolae Chitica, Wilmington, DE (US); Robert Lewen, Wilmington, DE (US); Christopher Kocot, Wilmington, DE (US); Julie Eng, Wilmington, DE (US)

(21) Appl. No.: 19/027,280

(22) Filed: Jan. 17, 2025

Related U.S. Application Data
(60) Provisional application No. 63/625,639, filed on Jan. 26, 2024.

(51) Int. Cl. G02B 6/42

(52) U.S. Cl. CPC G02B 6/425; G02B 6/4257

(57) ABSTRACT

This disclosure describes an integrated compound semiconductor co-packaged optics (CCPO) device. The CCPO device has a photonic integrated circuit (PIC) and an electronic integrated circuit (EIC) mounted on a common package substrate. The PIC has a modulator array and a photodetector (PD) array fabricated in GaAs and/or InP. In some configurations the PIC also has an amplifier array fabricated in GaAs and/or InP. The CCPO design reduces loss and signal integrity issues that are typically present when the PIC and EIC are on separate substrates.

### CROSS REFERENCE TO RELATED APPLICATIONS

This application claims priority to and the benefit of U.S. Provisional Patent Application No. 63/625,639 entitled “INTEGRATED COMPOUND SEMICONDUCTOR CO-PACKAGED OPTICS” filed Jan. 26, 2024, which is hereby incorporated herein by reference in its entirety.

### BACKGROUND

Limitations and disadvantages of traditional optical semiconductors will become apparent to one of skill in the art, through comparison of such approaches with some aspects of the present method and system set forth in the remainder of this disclosure with reference to the drawings.

### BRIEF SUMMARY

Systems and methods are provided for producing integrated compound semiconductor co-packaged optics (CCPO or compound CPO), substantially as illustrated by and/or described in connection with at least one of the figures, as set forth more completely in the claims.

### BRIEF DESCRIPTION OF THE DRAWINGS

FIG. 1 illustrates a side view of an example CCPO PIC implemented in InP, in accordance with various example implementations of this disclosure.

FIG. 2 illustrates a top view of an example CCPO PIC implemented in InP, in accordance with various example implementations of this disclosure.

FIG. 3 illustrates a top view of an example CCPO PIC implemented in GaAs, in accordance with various example implementations of this disclosure

### DETAILED DESCRIPTION

The following discussion provides various examples of systems and methods for producing integrated compound semiconductor co-packaged optics. Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

The integrated compound semiconductor co-packaged optics (CCPO or compound CPO), disclosed herein, are designed to transport high-capacity electronic data traffic from an electronic hyper-scale integrated circuit device (HSIC) into an optical interconnect. The disclosed CCPO photonic integrated circuit (PIC) may be implemented in indium phosphide (InP) or gallium arsenide (GaAs) substrates, depending on the targeted operating wavelength and/or the length of fiber links.

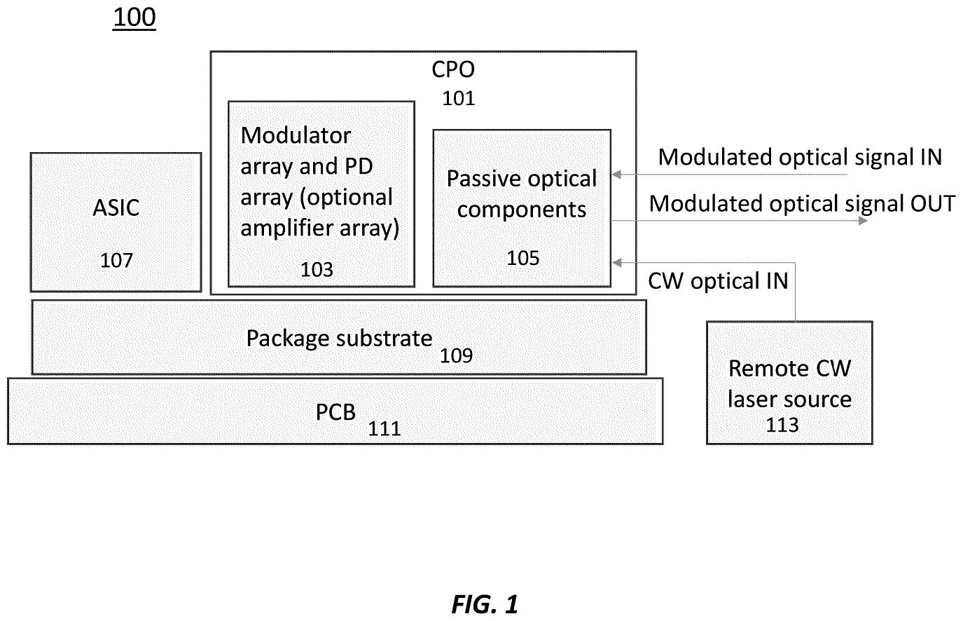

FIG. 1 (100) illustrates a side view of an example CCPO PIC implemented in InP, in accordance with various example implementations of this disclosure.

The CCPO device 100 may be co-packaged with an ASIC 107, such as an HSIC 107, within close proximity (e.g., on the order of millimeters) and housed in a single package assembly on a common package substrate 109 for mounting on a PCB 111. This design may reduce signal loss and integrity issues commonly associated with inter-substrate connections in prior art, where ASICs and optical components were housed on separate substrates.

Light may be coupled between fibers and a CCPO PIC 100 using external free space optics or waveguides via passive optical components 105 in the CPO 101. Light coupling may involve polarization, rotation, multiplexing, routing, grating, and/or beam expansion. For example, a light source may be shared across multiple modulators. Embedded light couplers 105 within the CPO 101, as well as tapered waveguide configurations, may be employed to facilitate coupling. Light outputs from the CCPO 100 may be directed to a single fiber or a fiber array hosting multiple wavelengths.

A CCPO 100 may integrate a configurable multi-lane (e.g., 2, 4, or 8 lanes/channels) modulator/amplifier array and photodetector (PD) array 103 on the same compound semiconductor substrate 109. These components may comprise electro-absorption modulators (EAMs), Mach-Zehnder modulators (MZMs), and various photodetectors such as PN detectors, PIN detectors, and avalanche photodiode detectors (APDs).

The CPO 101 may operate uncooled or with minimal cooling when using remote external lasers, as its modulators 103 may be optimized for high-temperature operation. Cooling may only be required for integrated laser solutions or when specific high-performance (e.g., up to 105° C.) conditions necessitate it.

Amplification capabilities may be incorporated on either the CPO side or a remote CW laser source 113. An integrated semiconductor optical amplifier (SOA) may be integrated into the modulator/amplifier array and PD array 103 to boost the output power of a laser source for enhanced distribution.

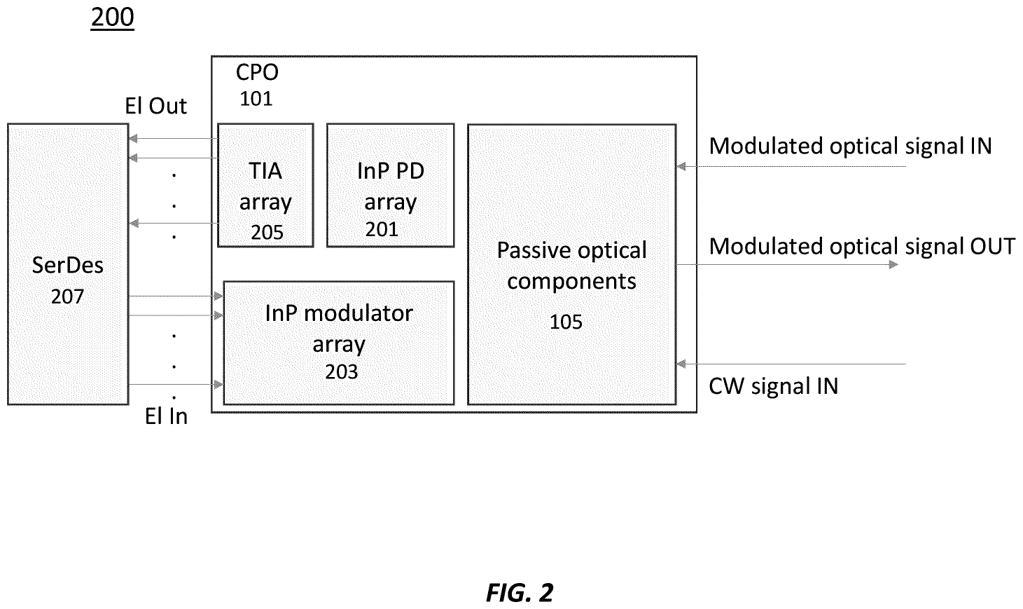

FIG. 2 (200) illustrates a top view of an example CCPO PIC implemented in InP, in accordance with various example implementations of this disclosure. FIG. 2 shows an uncooled InP modulator array 203 driven directly by an embedded serializer/deserializer (SerDes) 207 of a HSIC. A receiver portion may include an InP PD array 201. Modulator arrays 203 may be designed for single or multiple wavelengths for wavelength-division multiplexing (WDM) implementations.

Indium phosphide modulators may provide superior bandwidth, signal quality, and reliability under high-temperature conditions compared to silicon photonics. Silicon photonics typically achieve speeds of 100-200 Gbps, while InP enables speeds that may double that rate, offering a significant performance advantage.

The disclosed CCPO design replaces pluggable optics at the network edge, offering advantages such as increased bandwidth, reduced equalization needs, high-speed operation, compact designs, and better thermal management. Indium phosphide enables higher data transmission per lane than vertical-cavity surface-emitting lasers (VCSELs), while VCSELs offer cost efficiency and simplicity in specific applications.

A trans-Impedance amplifier (TIA) array 205 may comprise a companion electronic integrated circuit (EIC) with a driver array to increase the electrical signal strength from the modulators 203 and PDs 201 in the CCPO PIC 200.

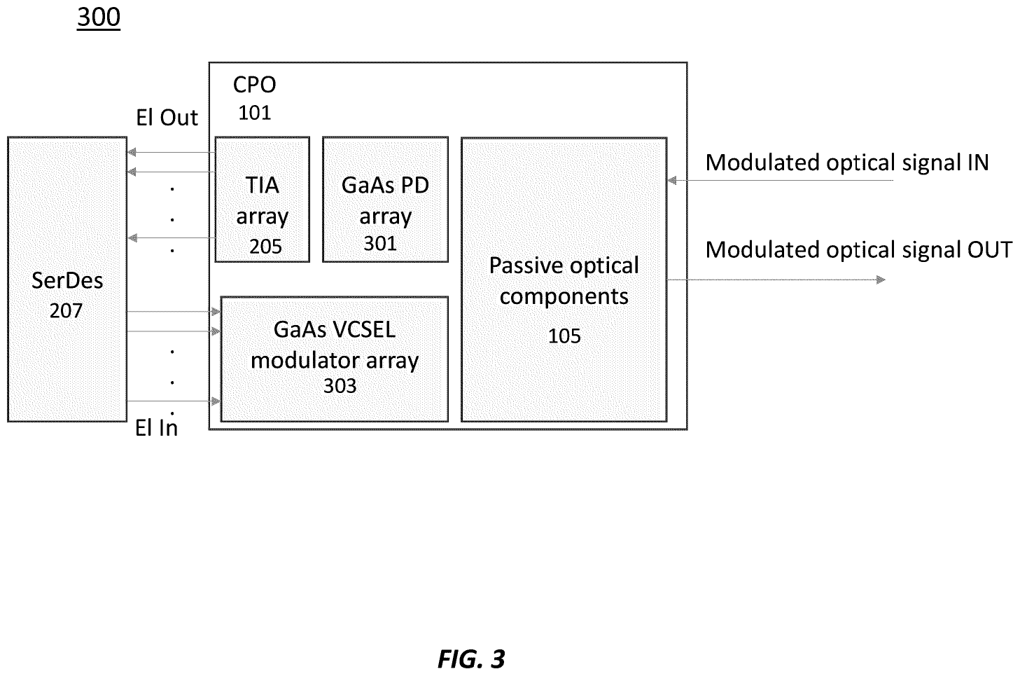

FIG. 3 (300) illustrates an alternative CCPO PIC implemented in GaAs, in accordance with various example implementations of this disclosure. GaAs modulator arrays 303, such as EAMs and MZMs, are designed for cost efficiency and may operate at slightly lower speeds than InP-based designs. High-speed modulators may also comprise other materials, such as lithium niobate (LiNbO₃), silicon-germanium (SiGe), perovskite BTO (BaTiO₃), and LTO (La₂Ti₂O₇). These arrays may be driven directly by the SerDes 207 of a HSIC, eliminating the need for external light sources. LEDs may also be direct modulated with VCSELs.

The receiver portion of CCPO PIC 300 may comprise a GaAs PD array 301. Detector arrays 301 and modulator arrays 303 may be implemented on the same die or on separate dies. The GaAs PD array 301 may comprise PIN detectors and/or avalanche photodiodes (APDs).

The TIA array 205 may be used to increase the electrical signal strength of signals received from the modulators 303 and PDs 301 in CCPO PIC 300.

The variation of the placement and/or size of each block in FIGS. 1-3 is also envisioned and disclosed herein.

By co-integrating components on a single substrate, the disclosed CCPO may reduce signal loss, improve speed, and enhance energy efficiency. Smaller compound devices may consume less energy, tolerate higher temperatures, and achieve higher speeds by being positioned closer to ASICs. This design supports high-capacity data transmission from GPUs, CPUs, TPUs, or memory, meeting the demands of hyperscale data centers.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A device comprising:
a photonic integrated circuit (PIC) and an electronic integrated circuit (EIC) mounted on a common package substrate, wherein the PIC comprises:
a modulator array;
a photodetector (PD) array;
an amplifier array configured to increase a signal strength from the modulator array and or the PD array; and
one or more passive optical components configured to transmit optical signals between the PIC and optical fibers.

2. The device of claim 1, wherein the modulator array comprises electro-absorption modulators (EAMs) and/or Mach-Zehnder modulators (MZMs).

3. The device of claim 1, wherein the one or more passive optical components are configured for polarization, rotation, multiplexing, routing, grating, and/or beam expansion.

4. The device of claim 1, wherein the modulator array is fabricated in one of indium phosphide (InP) and gallium arsenide (GaAs).

5. The device of claim 1, wherein the PD array is fabricated in one of indium phosphide (InP) and gallium arsenide (GaAs).

6. The device of claim 1, wherein the PIC is configured for 2, 4, or 8 lanes.

7. The device of claim 1, wherein the PIC comprise an indium phosphide (InP) semiconductor optical amplifier (SOA).

8. The device of claim 1, wherein the device operates uncooled using a remote continuous wave (CW) laser source.

9. The device of claim 1, wherein the PIC is operable to use wavelength-division multiplexing (WDM) to increase output signal density.

10. The device of claim 1, wherein the EIC is a hyper-scale integrated circuit (HSIC).

11. A device comprising:
a photonic integrated circuit (PIC) and a serializer/deserializer (SerDes) mounted on a common package substrate, wherein the PIC comprises:
a modulator array;
a photodetector (PD) array;
an amplifier array configured to increase a signal strength from the modulator array and or the PD array; and
one or more passive optical components configured to transmit optical signals between the PIC and optical fibers.

12. The device of claim 11, wherein the modulator array comprises electro-absorption modulators (EAMs) and/or Mach-Zehnder modulators (MZMs).

13. The device of claim 11, wherein the one or more passive optical components are configured for polarization, rotation, multiplexing, routing, grating, and/or beam expansion.

14. The device of claim 11, wherein the modulator array is fabricated in one of indium phosphide (InP) and gallium arsenide (GaAs).

15. The device of claim 11, wherein the PD array is fabricated in one of indium phosphide (InP) and gallium arsenide (GaAs).

16. The device of claim 11, wherein the PIC is configured for 2, 4, or 8 lanes.

17. The device of claim 11, wherein the PIC comprise an indium phosphide (InP) semiconductor optical amplifier (SOA).

18. The device of claim 11, wherein the device operates uncooled using a remote continuous wave (CW) laser source.

19. The device of claim 11, wherein wavelength-division multiplexing (WDM) is used to increase output signal density.

20. The device of claim 11, wherein the SerDes is embedded in a hyper-scale integrated circuit (HSIC).
